(19) United States
(12) Patent Application Publication
(10) Pub. No.: US 2023/0273982 A1
(43) Pub. Date: Aug. 31, 2023

(54) LOGIN CLASSIFICATION WITH SEQUENTIAL MACHINE LEARNING MODEL

(71) Applicant: Intuit Inc., Mountain View, CA (US)

(72) Inventors: Andreas Petros Mavrommatis, Mountain View, CA (US); Lin Tao, Fremont, CA (US); Hao Zheng, San Jose, CA (US)

(73) Assignee: Intuit Inc., Mountain View, CA (US)

(21) Appl. No.: 17/683,186

(22) Filed: Feb. 28, 2022

(51) Int. Cl. G06F 21/31; G06N 20/20

(52) U.S. Cl. CPC G06F 21/316; G06N 20/20

(57) ABSTRACT

A method includes extracting attribute values of attributes from login events, filtering the attribute values based on correlation between the attributes and classes to obtain filtered attributes values, and generating a vector embedding of the filtered attributes values to obtain login vectors. The method further includes executing a sequential machine learning model on the login vectors to determine a class of the classes, and outputting the class.

### BACKGROUND

Users use applications in order to obtain the services of the applications. In many cases, to use the application, the application creates a user account for the user that stores protected information for the user. The user logs into the application and accesses the user account in order to use the services of the application. To log into the account, the user directly or indirectly provides login credentials via an interface of the application. The login credentials are validated, and, if valid, the user can access the application including protected information stored in the user account of the user. Each time that the user logs into an account may be referred to as a login event.

### SUMMARY

In general, in one aspect, one or more embodiments relate to a method that includes extracting attribute values of attributes from login events, filtering the attribute values based on correlation between the attributes and classes to obtain filtered attributes values, and generating a vector embedding of the filtered attributes values to obtain login vectors. The method further includes executing a sequential machine learning model on the login vectors to determine a class of the classes, and outputting the class.

In general, in one aspect, one or more embodiments relate to a system that includes a computer processor. The system also includes an attribute collector executing on the computer processor and configured to extract attribute values of attributes from login events. The system also includes a correlation filter executing on the computer processor and configured to filter the attribute values based on correlation between the attributes and classes to obtain filtered attributes values. The system also includes a vector embedding model executing on the computer processor and configured to generate a vector embedding of the filtered attributes values to obtain login vectors. The system also includes a sequential machine learning model executing on the computer processor and configured to process the login vectors to determine a class of the classes.

In general, in one aspect, one or more embodiments relate to a method that includes receiving login event information of prelabeled login events labeled with classes, extracting, from the login event information, attribute values of attributes of the prelabeled login events, and filtering the attribute values of the attributes to obtain filtered attribute values for the prelabeled login events. The method also includes training a vector embedding model that learn an embedding of the filtered attribute values that groups the prelabeled login events based on user account, wherein the vector embedding model generates login vectors for the prelabeled login events. The method also includes training a sequential machine learning model on the login vectors to predict at least one class of the classes for the prelabeled login events.

Other aspects of the invention will be apparent from the following description and the appended claims.

### BRIEF DESCRIPTION OF DRAWINGS

FIG. 1 shows a diagram of a system in accordance with one or more embodiments.

FIG. 2 shows a flowchart for classifying login events in accordance with one or more embodiments.

FIG. 3 shows a flowchart for training in accordance with one or more embodiments.

FIGS. 4, 5, 6, 7, 8, and 9 show examples in accordance with one or more embodiments.

FIGS. 10A and 10B show a computing system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In general, embodiments of the invention are directed to classifying login events into one of many classes. For example, one or more embodiments may be configured to detect a security breach in the form of an account take over (ATO). An ATO occurs when a nefarious user (i.e., bad actor) logs into an account owned by another user (i.e., the legitimate user). The nefarious user impersonates the legitimate user, such as by stealing the user credentials of the legitimate user. Detecting ATO may be performed by defining two classes: a benign class and an ATO class. One or more embodiments may then classify the login events into either the benign class or the ATO class.

In one or more embodiments, classification of login events is performed through a several stage process. From a set of login events, attribute values of the attributes are extracted. The attribute values are filtered based on a correlation between attributes and classes. The correlation ranks attributes based on which attributes have attribute values that best distinguish between classes. Attribute values of attributes with the highest correlation are selected for further processing. Classification continues with a vector embedding model individually generating a vector embedding of the attribute values of each login event to obtain login vectors. A sequential machine learning model is executed on the login vectors in the order in which the login event occurs. The sequential machine learning model is trained to predict the class of the last login event based on the set of login events in the order.

Returning to the ATO example, one or more embodiments addresses the problem of automatically predicting whether the account of a user who is attempting to log into a target application has been taken over by a nefarious user. The nefarious user may have stolen or otherwise retrieved the credentials of a legitimate user to then log into the target application to perform malicious activities, such as steal the customer’s identity, personal or financial information, transfer funds to their bank account, or file a fake tax return to receive a refund. To address the problem of risk assessment, one or more embodiments is a machine learning model that returns a numerical score that indicates the probability that a particular login attempt is a result of ATO (i.e., is in the ATO class).

The sequential machine learning model considers information from each user’s individual history of logins in a sequential fashion. Based on this history, it returns a score that, if low, indicates that the current login is likely from the legitimate owner of the account or, conversely, if high, is likely a result of ATO. The information used to train the model may include attributes pertaining to each login provided by a third-party vendor. These attributes are primarily of textual format. From the filtered attributes, a paragraph-like textual representation for each login event is generated. The paragraph-like textual representation is encoded using a natural language processing (NLP) model to transform word documents into numerical arrays (e.g., a login vector). Then, for each user, we assemble an ordered sequence of such embeddings, each embedding representing a login from the user’s recent history. The sequences may be used as training data for a recurrent neural network (RNN) using the long-short term memory (LSTM) architecture, and use labels of known ATO, to train the LSTM model as a binary classifier. The final output is a score that indicates the ATO risk of each login.

The models may be deployed to production to output a score for real-time or asynchronous risk assessment. For example, real-time risk assessment involves determining whether a login event is ATO or benign while the user is attempting to perform the login. For real-time risk assessment, the user is permitted access if the login event is classified benign using embodiments disclosed herein whereas the user is blocked access if the login event is classified as ATO. Asynchronous risk assessment involves performing operations disclosed herein asynchronously from the login event, such as at a defined interval. Asynchronous risk assessment may be used to determine whether past login events of the user are ATO. For example, asynchronous risk assessment may be used to determine whether to perform or block actions that the user instantiated when the user was logged into the account.

Although the above is discussed in reference to an ATO example, the classification may be used for other use-cases, such as automating ATO labeling for training different models, categorizing login patterns, grouping users by similarity of their login behaviors, and identifying low-risk users.

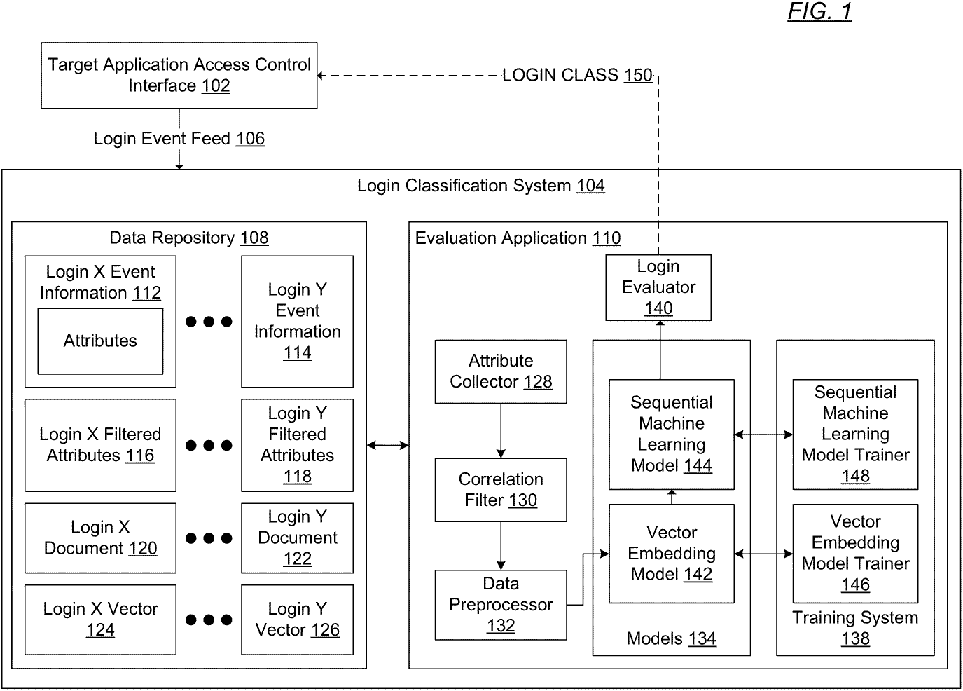

Turning to the Figures, FIG. 1 shows a diagram of a system in accordance with one or more embodiments. As shown in FIG. 1, the system includes a target application access control interface (102) connected to a login classification system (104). The target application access control interface (102) is an interface by which a user may log into a target application.

The target application is the application that provides a user access to user accounts (not shown). For example, the target application may be a web application, a local application, or other application that provides the user the ability to receive and/or modify protected information in the user’s account. In some embodiments, the information is financial information, and the user may manipulate the flow of money using the user account. In the present application, the user is any individual that is logging into a user account. The user is a legitimate user when the user is the account owner. An account owner is an authorized individual that is authorized to access the particular user account. The user is a nefarious user when the user is not authorized to access the user account. The login of the user may be performed through account credentials. The account credentials are the set of protected information by which a user authenticates themselves. Logging on may include, for example, single-factor or two-factor authentication.

The target application access control interface (102) is the interface through which the user may log into the user account of the target application. For example, the target application access control interface (102) may be a user interface, such as a graphical user interface that requests a username and password of the user. Any type of access control interface (102) may be used.

In one or more embodiments, the target application access control interface (102) is configured to transmit a login event feed (106) to the login classification system (104). The login event feed (106) is a set of login events, whereby each login event has login event information recording a single instance of a user attempting to login to a user account. In one or more embodiments, login events are transmitted to the login classification system (104) while the users are performing login operations. The login classification system (104) is a tool configured to classify login events. In one or more embodiments, the login classification system (104) includes a data repository (108) connected to an evaluation application (110).

The data repository (108) is any type of storage unit and/or device (e.g., a file system, database, collection of tables, or any other storage mechanism) for storing data. Further, the data repository (108) may include multiple different storage units and/or devices. The multiple different storage units and/or devices may or may not be of the same type or located at the same physical site.

The data repository (108) is configured to store event information (e.g., login event X information (112), login event Y information (114)), filtered attributes (e.g., login X filtered attributes (116), login Y filtered attributes (118)), login documents (e.g., login X document (120), login Y document (122)), and login vectors (e.g., login X vector (124), login Y vector (126)). The different types of data in the data repository (108) are described below.

Login event information, or event information, (e.g., login event X information (112), login event Y information (114)) includes the metadata gathered about the login event that is transmitted from the target application access control interface (102). For example, the event information may include a timestamp of the time in which the login event occurred. The event information includes attributes (128) describing the login event. Each attribute has an attribute value and an attribute label. The attribute value is the value of the attribute that is particular to the login event. The attribute label is an identifier of the type of attribute. In other words, the attribute label denotes the type of information that the attribute value represents. Attribute labels may be explicitly or implicitly specified in the event information (e.g., as name value pairs or based on position of the attribute value). Example attributes include a timestamp, an account identifier, location attributes, and device attributes. In one or more embodiments, attributes are textual attributes in the login event information.

Filtered attributes (e.g., login X filtered attributes (116), login Y filtered attributes (118)) are a subset of the attributes (128) in the login event information. Thus, the filtered attributes also have attribute values and corresponding implicitly or explicitly defined attribute labels. In one or more embodiments, the filtered attributes are the attributes whose attribute values correlate with a particular class. In other words, the filtered attributes can be used to distinguish between classes. By way of an example, consider the scenario in which an attribute can have an attribute value of V1, V2, and V3, and the classes are C1 and C2. If V1 occurs 90% of the time in login events assigned to C1, 10% of the time in login events assigned to C2; V2 occurs 60% of the time in login events assigned to C1, 40% of the time in login events assigned to C2; and V3 occurs in 10% of the time in login events assigned to C1, 90% of the time in login events assigned to C2, then the attribute is deemed to correlate with the class and may be selected as a filtered attribute. However, if V1 occurs 45% of the time in login events assigned to C1, 55% of the time in login events assigned to C2; V2 occurs 45% of the time in login events assigned to C1, 55% of the time in login events assigned to C2; and V3 occurs in 50% of the time in login events assigned to C1, 50% of the time in login events assigned to C2, then the attribute is determined not to correlate with the class and may be removed.

In some embodiments, the combination of attributes is considered for the correlation. For example, the values of a first attribute combined with the values of the second attribute may correlate with different classes. Thus, the combination can be used to distinguish between classes. In such a scenario, the filtered attributes include the collection of attributes.

Continuing with the data repository (108), the documents (e.g., login X document (120), login Y document (122)) are textual groupings of the filtered attribute. For example, each document may be in paragraph format whereby attributes are included as text strings that are grouped together. The grouping may be a concatenation of the filtered attributes, where each attribute is one or more words. Attributes in each document may be ordered, such that each document has the same order as the other documents. The document may include attribute label, attribute value pairs, or just attribute values.

A login vector (e.g., login X vector (124), login Y vector (126)) is a vector embedding of the filtered attributes. The login vector is a numerical vector generated though a natural language processing technique. In one or more embodiments, the login vector is a numerical encoding of the document, thereby being a numerical encoding of the login event.

Continuing with FIG. 1, an evaluation application (110) is communicatively connected to the data repository (108). For example, the evaluation application (110) may be a software application configured to retrieve and store data in the data repository (108). The evaluation application (110) includes an attribute collector (128), a correlation filter (130), a data preprocessor (132), models (134), a training system (138), and a login evaluator (140).

The attribute collector (128) is configured to parse the login event feed and identify individual login events and individual attributes in the login event feed. The attribute collector (128) is further configured to extract attributes and associate the attributes of a login event with a login event identifier of the login event.

The correlation filter (130) is configured to determine a correlation between attributes and classes. The correlation filter is configured to calculate a correlation coefficient for each combination of one or more attribute(s) and class. The output of the correlation is a ranking of attributes or subsets of attributes. The correlation filter is further configured to select a subset of attribute labels that have the greatest correlation. In one or more embodiments, the correlation filter (130) is configured to maintain a list of attribute labels based on the correlation. The correlation filter to filter attributes from login event information and generate login filtered attributes.

The data preprocessor (132) is configured to generate a document for each login event. Namely, the data preprocessor is configured to transform the set of filtered attributes for a login event into the login event’s own document. Preprocessing may be performed to remove common words and attribute labels and perform normalization.

The data preprocessor (132) provides the documents to the models (134). The models are machine learning models that are trained using training system (138). The models include a vector embedding model (142) trained with a vector embedding model trainer (146) and a sequential machine learning model (144) trained with a sequential machine learning model trainer (148).

The vector embedding model (142) is a machine learning model that is configured to generate a login vector from the attributes. The vector embedding model (142) is trained by the vector embedding model trainer (146) to generate vectors that are close to each other in vector space when the vectors are for login events from the same user or same type user; and that are farther from each other in vector space when the vectors are for events from different users. Because the vector embedding considers filtered attributes that are filtered based on classes, the byproduct of the vector embedding is login vectors that are close to each other when the corresponding login events are assigned to the same class and separate from each other when assigned to different classes. The vector embedding model trainer (146) does not use the class in the training data to generate the vector embedding model. In one or more embodiments, the vector embedding model is a Doc2Vec model. Doc2Vec is neural network model. Other natural language processing models that generate vector embeddings may be used as the vector embedding model in one or more embodiments.

Continuing with FIG. 1, the sequential machine learning model (144) is a machine learning model trained by the sequential machine learning model trainer (148) to process the login vector and generate scores for one or more classes. The scores are the probability that the login event corresponding to the login vector is assigned to the particular login class. The sequential machine learning model (144) is based on a history of the account owner’s logins. Namely, the sequential machine learning model (144) processes a series of login vectors in sequential order of timestamp and generates a prediction for the last login event of the series. When the sequential machine learning model receives a new login event, the sequential machine learning model adds the login vector of the new login event to the end of the series and generates the scores for the new login event. An example of a sequential machine learning model (144) is a long short term memory (LSTM) model.

The sequential machine learning model (144) is connected to a login evaluator (140). The login evaluator (140) is configured to determine, based on the score, the class (i.e., login class (150)) of the login event. For example, the login evaluator (140) may select the class having the highest score. As another example, the login evaluator (140) may select the class when the score is greater than a threshold. In one or more embodiments, the login evaluator (140) may be configured to output the login class (150) of the login event. The output may be to the target application access control interface (102) (e.g., to allow or deny a user access), to the data repository (108), and/or to a different component of the system.

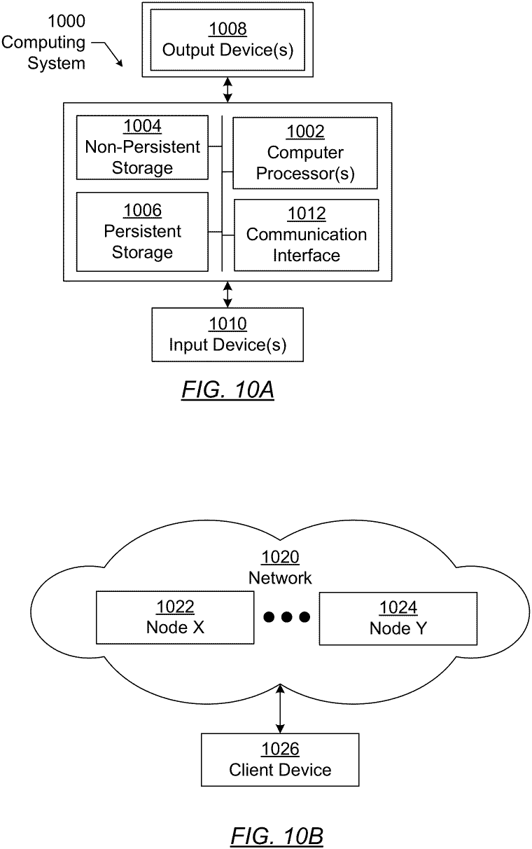

The target application access control interface (102) and the login classification system (104) may execute on any computing system, such as the computing system shown in FIGS. 10A and 10B. For example, the target application access control interface may execute on an application server and the login classification system may be an identity server.

While FIG. 1 shows a configuration of components, other configurations may be used without departing from the scope of the invention. For example, various components may be combined to create a single component. As another example, the functionality performed by a single component may be performed by two or more components.

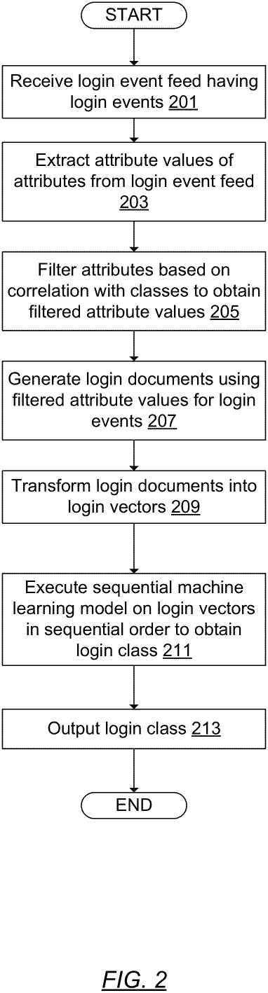

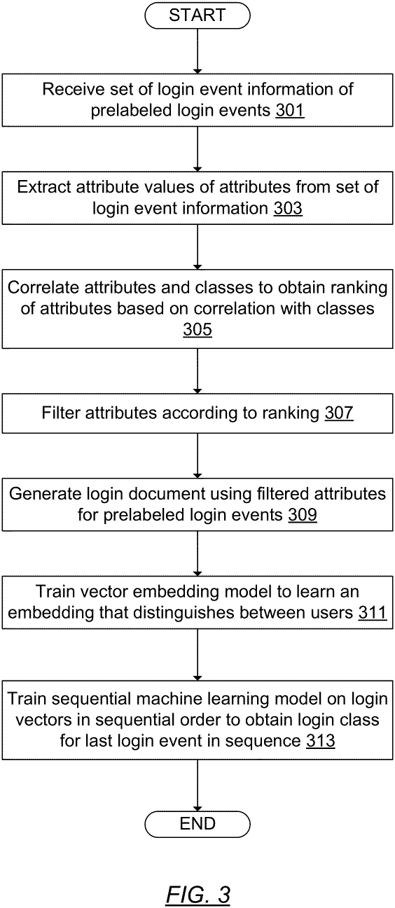

FIG. 2 and FIG. 3 show flowcharts in accordance with one or more embodiments. FIG. 2 shows a flowchart for classifying login events and FIG. 3 shows a flowchart for training the system in accordance with one or more embodiments. While the various steps in these flowcharts are presented and described sequentially, one of ordinary skill will appreciate that some or all of the steps may be executed in different orders, may be combined, or omitted, and some or all of the steps may be executed in parallel.

Turning to FIG. 2, in block 201, a login event feed having login events is received. The login event feed may be a batch collection of login events and/or series of login events received over time. Receiving the login event stream may be through a network connection established with the target application access control interface.

In block 203, attribute values of attributes are extracted from the login event feed. The attribute collector partitions the login event feed into login events. The attribute collector then parses the login events into individual attributes. As part of parsing login events, the attributes may be transformed into a different format for consumption by the evaluation application. The transformation may include mapping individual attribute values to different attribute values based on ranges, performing a data type transformation, or performing another transformation.

In block 205, the attributes are filtered based on the correlation with the classes to obtain filtered attribute values. From the set of attributes extracted, the attributes are filtered so that only a strict subset of attributes are selected for further processing. The filtering may be performed by removing attributes that are not in the predefined list of attributes. Blocks 203 and 205 may be performed concurrently by only extracting attributes that are in the predefined list of attributes.

In block 207, login documents are generated using filtered attribute values for login events. Individually, on a per login event basis, the data preprocessor concatenates the filtered attribute values into a document, whereby the document has each attribute value as one or more words. The document is paragraph style. In one or more embodiments, the attribute values are ordered in the document according to a predefined order. After block 207, each login event has a separate and individual corresponding document from the other login events.

In block 209, the login documents are transformed into login vectors. The vector embedding model individually processes each login document to obtain a login vector for the login document. The login vector is a vector of numbers.

Generally, blocks 207 and 209 describe generating a vector embedding from the filtered attribute values. Generating the vector embedding may be performed directly on the subset of attribute values or through the use of another intermediate representation without departing from the scope of the claims.

In block 211, a sequential machine learning model is executed on the login vectors in sequential order to obtain a login class. The sequential machine learning model processes each login vector in an order defined by the timestamps of the corresponding login events. In one or more embodiments the sequential machine learning model is an LSTM model whereby the long short-term refers to the fact that LSTM is a model for the short-term memory which can last for a long period of time. An LSTM is designed to classify, process, and predict time series data given time lags of unknown size and duration between events. In the present application, the LSTM uses the historical information of the account owner from previous login events to make predictions about new login events. In one or more embodiments, the sequential machine learning model processes the login vectors of login events individually for an account owner. Thus, the processing of login events to one account owner’s account does not affect the processing of another account owner’s account. In one or more embodiments, to perform the individual processing, the login vectors are separated into individual groups for each account owner or for each user account. The output of the sequential machine learning model is a score for a login class.

In block 213, the login class is outputted. The predicted login class may be transmitted to a target application access control interface to allow or deny access, to the target application to determine whether to perform a particular operation, or to a separate component.

FIG. 3 shows a flowchart for training the evaluation application in one or more embodiments. In block 301, a set of login event information of prelabeled login events is received. The set of login event information has login events for a variety of user accounts and for a variety of classes. The login events are prelabeled with the correct class. Some classes may be sparsely populated in the login event information. For example, if embodiments are directed to classifying login events into benign or ATO, in a million login events, only a few dozen may be ATO. The pre-labeling may be performed by a human or performed by a different component of the system.

In block 303, attribute values of attributes are extracted from the set of login event information. Extracting the attribute values may be performed in a same or similar technique described above with reference to block 203 of FIG. 2.

In block 305, the attribute and the classes are correlated to obtain a ranking of attributes based on the correlation with the classes. The correlation may be performed by calculating a correlation coefficient for each combination of one or more attributes and classes. Another way is to look for the distribution pattern that is similar to a particular class distribution. The closer the similarity, then the higher the correlation value for the attribute and class.

The correlation searches for unusual attribute values of a particular user behavior (e.g., class). The result of the correlation is a ranking of attributes. From the ranking, a subset of attributes is selected. A predefined number of the highest correlated attributes in ranking form the list of attribute labels.

For example, with ATO, the correlation may be performed by correlating each attribute individually with rate of ATO. If each login event has one hundred attributes, the correlation may identify the top thirty attributes that are most frequently associated with ATO.

In block 307, the attributes are filtered according to the ranking. In block 309, a login document is generated using the filtered attributes for prelabeled login events. Filtering the attributes and generating the document may be performed using a same or similar technique discussed above with reference to blocks 205 and 207 of FIG. 3.

In block 311, a vector embedding model is trained to learn an embedding that distinguishes between users. The class labels are not used to train the vector embedding model. Rather, the user account or account owner may be used in conjunction with the documents to train the vector embedding model. Because the subset of attributes is used based on correlation with classes, the result is a vector embedding model that also separates login events that are in different classes and groups login events in the same class. After training the vector embedding model, login vectors are generated for the prelabeled login events using the vector embedding model.

In block 313, a sequential machine learning model is trained on the login vectors in sequential order to obtain the login class for the last login event in the sequence. The login vectors are partitioned into groups for different account owners. Each group corresponds to one or more training examples. Thus, a training example that is used to train the sequential machine learning models has only the login vectors of a single account owner. Each group is ordered according to the timestamp, such that the login events are processed in sequential order. The sequential machine learning model is then trained with the group of login vectors in the sequential order. The goal of the training is that the predicted login class matches the prelabeled login class. The sequential machine learning model trainer calculates a loss function and updates the weights of the sequential machine learning model based on whether the predicted login class matches. Through training, the sequential machine learning model is updated to decrease the loss from the correct class of the login event.

Once trained, the system may be used to perform the operations of FIG. 2. Training may continue during use as new accurately labeled login events are received to continue to update the accuracy of the login classification system.

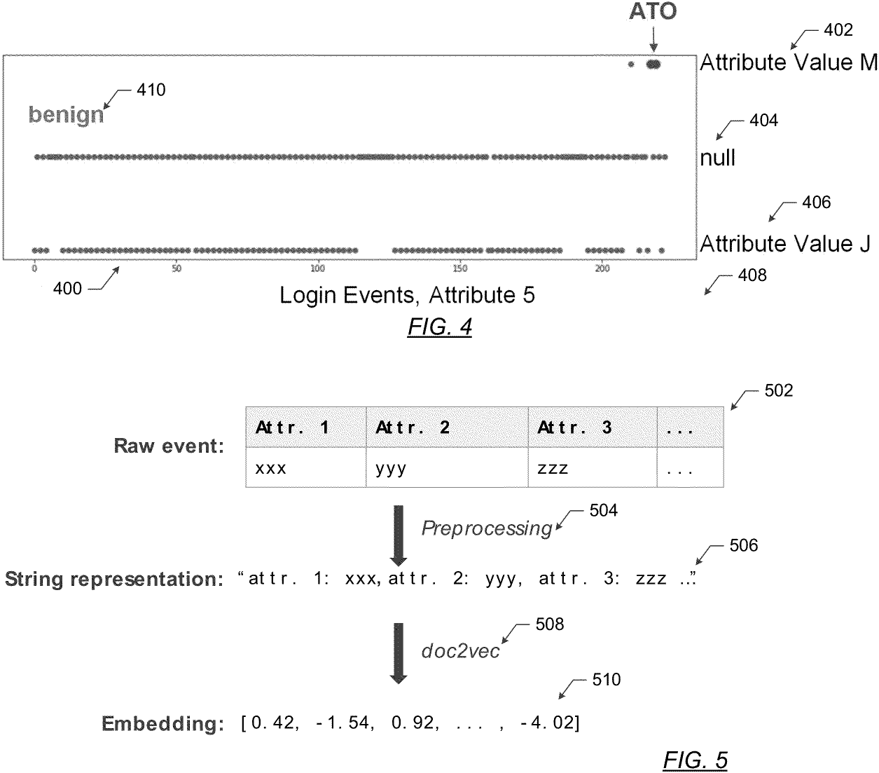

FIGS. 4-9 show examples in which the classes are benign class and ATO event class in accordance with one or more embodiments. The following examples are for explanatory purposes only and not intended to limit the scope of the invention. Turning to FIG. 4, FIG. 4 shows a diagram of a distribution of a particular attribute “Attribute 5”. The horizontal axis (400) is the index of login events in temporal order. The vertical axis are three attribute values “attribute value J” (406), null (404), and “attribute value M” (402). The fill of the circles reflects the prelabeled class. As shown in FIG. 4, Attribute 5 is highly correlated to the classes. For example, when Attribute 5 has attribute value M (402), there are only a few login events, with most of the login events being assigned the ATO class (408). In contrast, when Attribute 5 has no value (i.e., null) (404) or attribute value J (406), there are hundreds of login events, with all of the login events being assigned the benign class (410). Thus, the distribution of the attribute values for Attribute 5 is consistent with and therefore correlated with the distribution of the benign class (410) and the ATO class (408). Accordingly, Attribute 5 is selected. If, however, several of the sparse ATO classified login events were to have the attribute value of null or attribute value J, then the Attribute 5 would not be correlated to the classes and would not be selected.

FIG. 5 show a diagram for performing vector embedding. The raw login event has attribute labels and attribute values (502) for filtered attributes (e.g., attr. 1, attr. 2, attr. 3). Through preprocessing (504), the attributes are grouped into a string representation (506) having attribute value, attribute label pairs. In the example, “attr1: xxx, attr2: yyy, ...” is just an example representation and other representations, such as “attr1_xxx attr2_yyy ...” may be used. Doc2Vec (508) is applied to the string representation (506) to generate a vector embedding (510), which is a numerical vector.

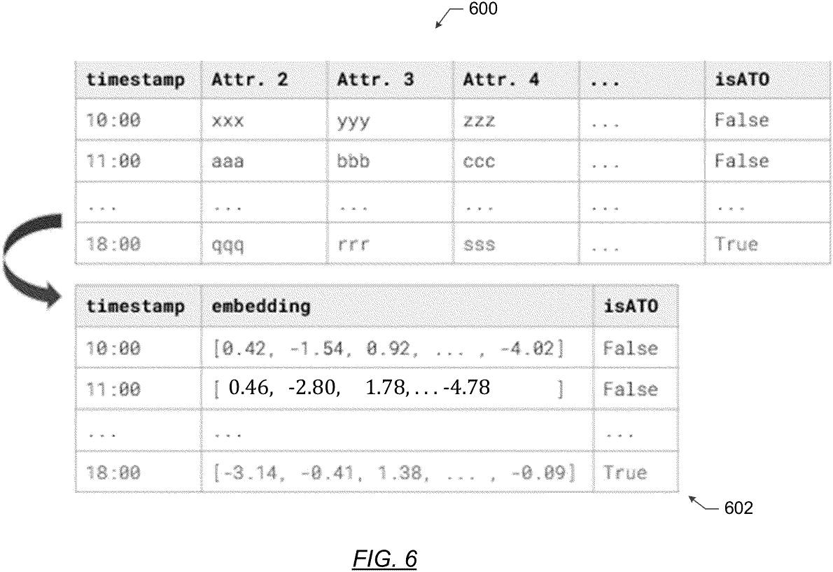

FIG. 6 shows an example set of prelabeled login event attributes (600) transformed into login vectors (602) in accordance with one or more embodiments. Each row corresponds to an individual login event. As shown, each login event in the training data has a timestamp and a label defining the class. The vector embedding only creates a login vector for the attribute values, the timestamp and class remain in the raw format. The timestamp is used to maintain the order of the login events. The label is used to train the sequential machine learning model.

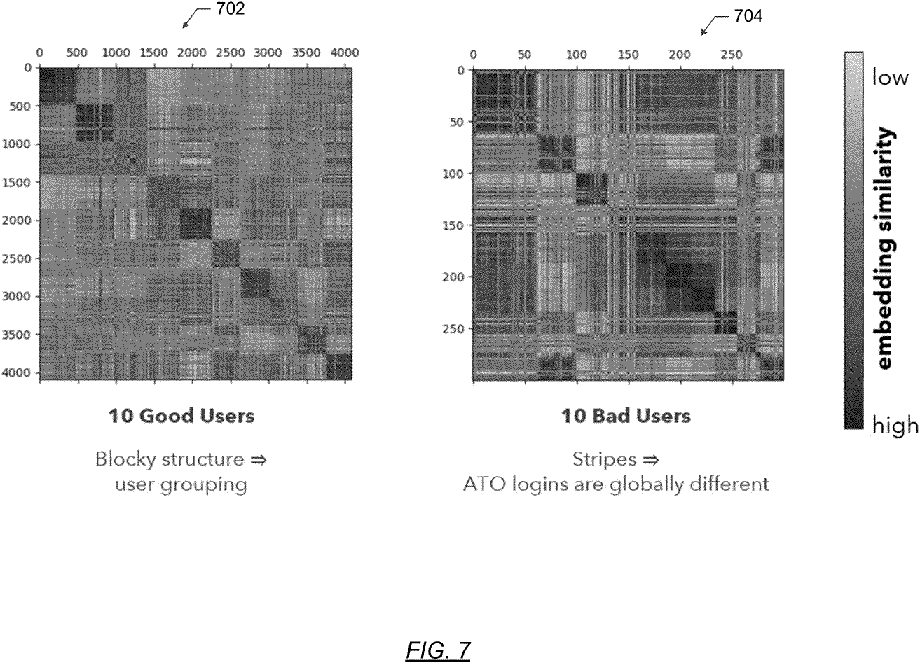

FIG. 7 shows example charts of vector embeddings of login vectors. The chart on the left (702) shows login vectors that are generated for login events of 10 good users whereas the chart on the right (704) shows login vectors of login events of 10 bad users. In the example of FIG. 7, both horizontal and vertical axes are indices of login events in temporal order for 10 different users. For example, in the chart on the left (702), the first ~500 indices correspond to 500 ordered logins from the same user, then the subsequent ~500 are from a separate user. In these matrices, the color of a cell (i, j) denotes the cosine similarity between the embedding with index i and the embedding with index j. The higher the similarity, the more similar the logins are interpreted to be. Cosine similarity has a symmetry property (i.e., the similarity of (i, j) equals the similarity of (j, i)), and therefore, the matrices themselves are symmetric. Also, the similarity of an embedding with itself (i, i) has by definition the highest possible similarity value as shown by the dark color in the diagonal of each matrix. In the chart on the left of good users (702), the block structure indicates that login events from individual users are mainly similar to their own login events, but different from login events from every other user. In the chart on the right of bad users (704), the stripes indicate that the ATO login events are different than benign login events.

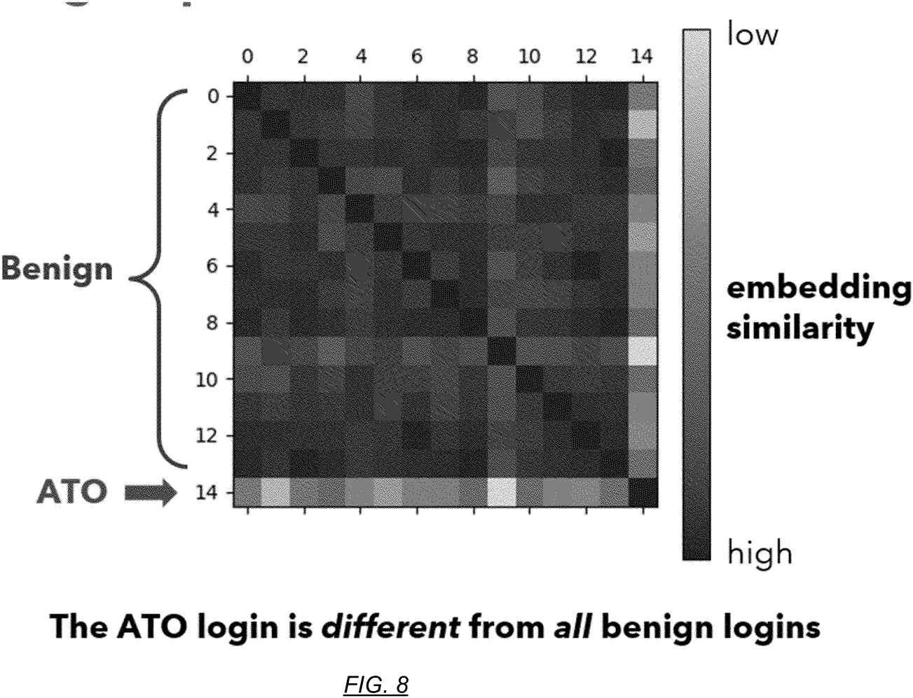

FIG. 8 shows an example chart (800) of vector embeddings for benign login events as compared to ATO login events from the same user. Because the vector embeddings are dependent on the correlated set of attributes, the byproduct of the dependency is that for the ATO login events, the login vector is completely different than for the benign login events. Stated another way, the benign login events are in a similar region in vector space, which is different from the ATO login event. However, because the vector embedding model is not trained using the class of the login event, the similarly is a byproduct of the input to the vector embedding model and the training of the vector embedding model on account owner basis.

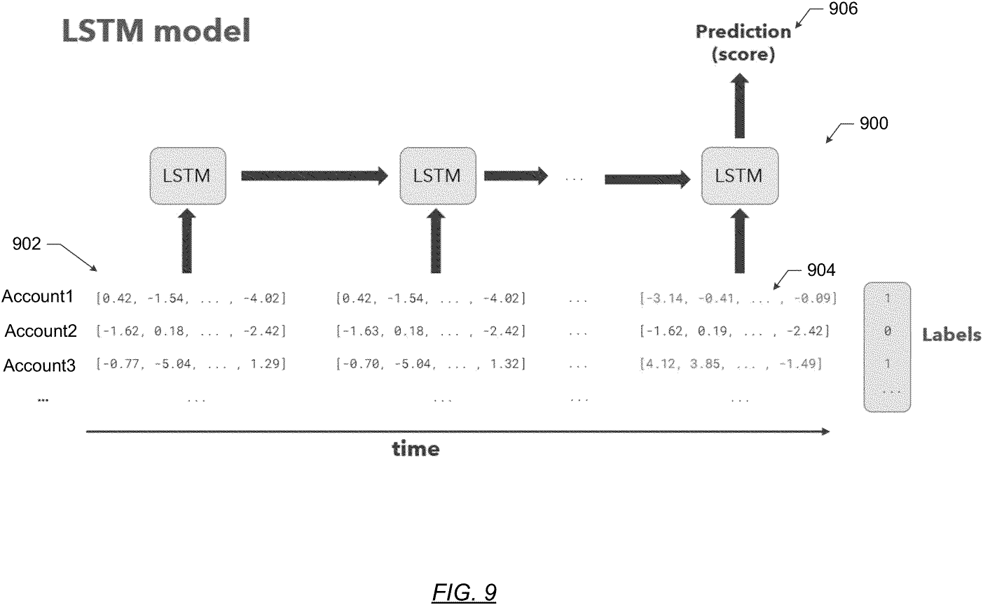

FIG. 9 shows an example of an LSTM model (900) in accordance with one or more embodiments. Individually, for each user account, the LSTM model (900) processes a timestamped ordered sequence of login events (902). Through processing, the LSTM model learns the history of the user account. Thus, for the last login event (904), the LSTM model is able to output a prediction score (906) indicating how likely the login event is ATO.

In some embodiments, the login events other than the last event that are classified in the ATO class are excluded from the sequence. In other embodiments, all login events that are classified in the ATO class are included in the sequence. Including the login events classified in the ATO class may improve accuracy of the classification.

Embodiments of the invention may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 10A, the computing system (1000) may include one or more computer processors (1002), non-persistent storage (1004) (e.g., volatile memory, such as random access memory (RAM), cache memory), persistent storage (1006) (e.g., a hard disk, a flash memory, etc.), a communication interface (1012) (e.g., Bluetooth interface, infrared interface, network interface, optical interface, etc.), and numerous other elements and functionalities that implement the features and elements of the disclosure.

The computer processor(s) (1002) may be an integrated circuit for processing instructions. For example, the computer processor(s) may be one or more cores or micro-cores of a processor. The computing system (1000) may also include one or more input devices (1010), such as a touchscreen, keyboard, mouse, microphone, touchpad, electronic pen, or any other type of input device.

The communication interface (1012) may include an integrated circuit for connecting the computing system (1000) to a network (not shown) (e.g., a local area network (LAN), a wide area network (WAN) such as the Internet, mobile network, or any other type of network) and/or to another device, such as another computing device.

Further, the computing system (1000) may include one or more output devices (1008), such as a screen, a printer, external storage, or any other output device. One or more of the output devices may be the same or different from the input device(s). The input and output device(s) may be locally or remotely connected to the computer processor(s) (1002), non-persistent storage (1004), and persistent storage (1006). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a storage device, a diskette, flash memory, physical memory, or any other computer readable storage medium. Specifically, the software instructions may correspond to computer readable program code that, when executed by a processor(s), is configured to perform one or more embodiments of the invention.

The computing system (1000) in FIG. 10A may be connected to or be a part of a network. For example, as shown in FIG. 10B, the network (1020) may include multiple nodes (e.g., node X (1022), node Y (1024)). Each node may correspond to a computing system, such as the computing system shown in FIG. 10A, or a group of nodes combined may correspond to the computing system shown in FIG. 10A. By way of an example, embodiments of the invention may be implemented on a node of a distributed system that is connected to other nodes. By way of another example, embodiments of the invention may be implemented on a distributed computing system having multiple nodes, where each portion of the invention may be located on a different node within the distributed computing system. Further, one or more elements of the aforementioned computing system (1000) may be located at a remote location and connected to the other elements over a network.

The nodes (e.g., node X (1022), node Y (1024)) in the network (1020) may be configured to provide services for a client device (1026). For example, the nodes may be part of a cloud computing system. The nodes may include functionality to receive requests from the client device (1026) and transmit responses to the client device (1026). The client device (1026) may be a computing system, such as the computing system shown in FIG. 10A. Further, the client device (1026) may include and/or perform all or a portion of one or more embodiments of the invention.

The computing system or group of computing systems described in FIGS. 10A and 10B may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user’s selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the invention, may extract one or more data items from the obtained data. For example, the extraction may be performed as follows by the computing system in FIG. 10A. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail-such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The above description of functions presents only a few examples of functions performed by the computing system of FIG. 10A and the nodes and/ or client device in FIG. 10B. Other functions may be performed using one or more embodiments of the invention.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In the above description, numerous specific details are set forth in order to provide a more thorough understanding. However, it will be apparent to one of ordinary skill in the art that the invention may be practiced without these specific details. In other instances, well-known features have not been described in detail to avoid unnecessarily complicating the description.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1-20. (canceled)

21. A method comprising:
obtaining a plurality of filtered attribute values of a plurality of filtered attributes from a plurality of login events, the plurality of filtered attribute values being obtained based on correlation between the plurality of select attributes and a plurality of classes;
generating, based on using a vector embedding model to embed the plurality of filtered attributes values, a plurality of login vectors;
selecting, based on executing a sequential machine learning model on the plurality of login vectors, a class of the a login event in the plurality of login events from the plurality of classes; and
outputting the class.

22. The method of claim 21, wherein obtaining the plurality of select attribute values of the plurality of select attributes comprises:
extracting a plurality of attribute values of a plurality of attributes from a plurality of login events,
filtering the plurality of attributes based on correlation between the plurality of attributes and the plurality of classes to obtain a plurality of filtered attributes, and
obtain a plurality of select attributes values corresponding to the plurality of filtered attributes.

23. The method of claim 21, further comprising:
generating a login document for the login event using a subset of the plurality of filtered attributes values that correspond to the login event; and
transforming the login document to a login vector of the plurality of login vectors.

24. The method of claim 23, wherein generating the login document comprises concatenating the plurality of filtered attribute values into paragraph form.

25. The method of claim 23, wherein transforming the login document to the login vector comprises generating the vector embedding of the login document.

26. The method of claim 21, further comprising:
inputting, into the sequential machine learning model, the plurality of login vectors in an order defined by a corresponding time of each the plurality of login events; and
receiving, from the sequential machine learning model, the class of a last login event according to the order.

27. The method of claim 21, wherein the sequential machine learning model outputs a value indicating a probability that a login vector of the plurality of login vectors is in the class, and wherein determining the class comprises determining whether the value satisfies a threshold.

28. The method of claim 21, wherein the plurality of classes comprises a first class that indicates that the login event is benign and a second class that indicates that the login event is associated with an account take over (ATO).

29. The method of claim 21, further comprising:
generating a plurality of vector embeddings of the plurality of filtered attribute values using a vector embedding model,
wherein the vector embedding model is trained to generate vector embeddings that are grouped based on corresponding user account.

30. The method of claim 21, further comprising:
receiving a login event feed from a target application access control interface, the login event feed comprising the plurality of login events.

31. The method of claim 21, further comprising:
blocking access to a user account based on the class of the login event.

32. A system comprising:
a computer processor;
an attribute collector executing on the computer processor and configured to extract a plurality of attribute values of a plurality of attributes from a plurality of login events;
a correlation filter executing on the computer processor and configured to filter the plurality of attribute values based on correlation between the plurality of attributes and a plurality of classes to obtain a plurality of filtered attributes values;
a vector embedding model executing on the computer processor and configured to generate a vector embedding of the plurality of filtered attributes values to obtain a plurality of login vectors; and
a sequential machine learning model executing on the computer processor and configured to process the plurality of login vectors to determine a class of the plurality of classes.

33. The system of claim 32, further comprising:
a data preprocessor configured to:
generate a login document for a login event using a subset of the plurality of filtered attributes values that correspond to the login event,
wherein the vector embedding model is configured to generate the vector embedding of the login document.

34. The system of claim 32, wherein:
the sequential machine learning model is configured to:
process the plurality of login vectors in an order defined by a corresponding time of each the plurality of login events, and
output the class of a last login event according to the order.

35. The system of claim 34, wherein the sequential machine learning model outputs a value indicating a probability that a login vector of the plurality of login vectors is in the class.

36. The system of claim 35, further comprising:
a login evaluator executing on the computer processor and configured to determine whether the value satisfies a threshold.

37. The system of claim 32, further comprising:
a target application access control interface configured to transmit a login event feed comprising the plurality of login events to a login classification system,
wherein the login classification system comprises the attribute collector, the correlation filter, the vector embedding model, and the sequential machine learning model.

38. A method comprising:
receiving login event information of a plurality of prelabeled login events labeled with a plurality of classes;
extracting, from the login event information, a plurality of attribute values of a plurality of attributes of the plurality of prelabeled login events;
filtering the plurality of attribute values of the plurality of attributes to obtain a plurality of filtered attribute values for the plurality of prelabeled login events;
training a vector embedding model to learn an embedding of the plurality of filtered attribute values that groups the plurality of prelabeled login events based on user account, wherein the vector embedding model generates a plurality of login vectors for the plurality of prelabeled login events; and
training a sequential machine learning model on the plurality of login vectors to predict at least one class of the plurality of classes for the plurality of prelabeled login events.

39. The method of claim 38, further comprising:
correlating the plurality of attributes and the plurality of classes to obtain a ranking of attributes based on the correlation with the plurality of classes; and
configuring a correlation filter according to the ranking, wherein the correlation filter filters the plurality of attributes.

40. The method of claim 38, wherein training the sequential machine learning model is performed independently for each account owner.
